(19) United States
(12) Patent Application Publication
(10) Pub. No.: US 2026/0267724 A1
(43) Pub. Date: Sep. 10, 2026

(54) METHOD AND APPARATUS OF DETECTING FAULT FOR EXTERNAL DEVICE

(71) Applicant: SUZHOU METABRAIN INTELLIGENT TECHNOLOGY CO., LTD., Suzhou, Jiangsu (CN)

(72) Inventors: Hao WANG, Suzhou, Jiangsu (CN); Xinglong WANG, Suzhou, Jiangsu (CN); Jinfeng LI, Suzhou, Jiangsu (CN); Qingwei ZHAI, Suzhou, Jiangsu (CN); Haoyu YANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/127,300

(22) PCT Filed: Mar. 12, 2024
(86) PCT No.: PCT/CN2024/081248

§ 371 Date: May 5, 2025

(30) Foreign Application Priority Data
Jun. 5, 2023 (CN) 202310657313.3

(51) Int. Cl. G06F 11/07

(52) U.S. Cl. CPC G06F 11/0766; G06F 11/22; G06F 11/2247; G06F 11/2268; G06F 11/2284; G06F 11/2289; G06F 11/2205

(57) ABSTRACT

A method and an apparatus of detecting a fault an external device are provided. The method includes: in a case where target information comprises first error information, injecting the first error information into the external device, and in a case where the target information comprises first register data, sending the first register data to a Basic Input Output System (BIOS), in response to second error information; acquiring a first log and/or a second log reported by the BIOS; and determining a running state of the external device according to the first log and standard register data corresponding to the first error information, and/or determining a running state of the BIOS according to the second log and a standard log corresponding to the first register data.

### CROSS-REFERENCE TO RELATED APPLICATION

The present application claims priority to Chinese Patent Application No. 202310657313.3, filed to the China National Intellectual Property Administration on Jun. 5, 2023 and entitled “Method and Apparatus of Detecting Fault for External Device”, the application of which is hereby incorporated by reference in its entirety.

### TECHNICAL FIELD

Embodiments of the present application relate to the field of computers, and in particular, to a method and an apparatus of detecting a fault for an external device, a computer non-volatile readable storage medium, a processor, and a fault detection system for a server.

### BACKGROUND

In recent years, in the field of servers, a Peripheral Component Interconnect Express (PCIe) (a high-speed serial computer expansion bus standard) device has been widely used due to functional features such as high-speed serial point-to-point dual-channel high-bandwidth transmission, support for active power management, error reporting, end-to-end reliable transmission, hot plugging, and Quality of Service (QoS). At the same time, in order to deal with various correctable errors or uncorrectable errors that may occur when the PCIe device runs, a PCIe protocol specifies a series of error reporting and recovery mechanisms such as an Integrated I/O module (IIO), PCIe advanced error reporting (Aer), and downstream port containment (edpc). Thanks to the above perfect mechanisms, Basic Input Output System (BIOS) solutions such as a Unified Extensible Firmware Interface (UEFI) and Coreboot (an open source firmware project) implement a variety of PCIe fault processing flows according to values stored in corresponding registers of the above mechanisms, including, but are not limited to, a PCIe correctable error threshold, an uncorrectable error processing medium such as an Operating System (OS) kernel or a BIOS, a PCIe error reporting mechanism such as recording as a System Event Log (SEL) on a Baseboard Management Controller (BMC) side, or an electronic logbook (elog) on an OS kernel side, etc.

In order to implement and verify these complex PCIe fault processing flows, the most common implementation in the industry is to use an eXpress Data Path (XDP) tool or an einj tool to simulate error injection, observe whether the values in the above registers respond correctly, and further verify error processing, error reporting, and error recovery flows. This implementation relies on an error injection tool, and a test script is difficult to integrate into a system. At the same time, whether the values in the above registers respond correctly after the error injection is completed (or a real error occurs) is often determined by the characteristics of the PCIe device itself or a Central Processing Unit (CPU), and a fault point cannot be effectively located in a case of incorrect response.

### SUMMARY

Embodiments of the present application provide a method and an apparatus of detecting a fault for an external device, a computer non-volatile readable storage medium, a processor, and a system of detecting a fault for a server, so as to at least solve the problem in the related art that a fault point cannot be effectively located by a fault location solution of the external device.

According to an optional embodiment of the present application, a method of detecting a fault for an external device is provided. The external device is in communication connection with a BIOS. The method includes: S1, executing a preset operation according to target information, wherein the executing a preset operation according to target information includes: in a case where the target information includes first error information, executing the preset operation of injecting the first error information into the external device, and in a case where the target information includes first register data, executing the preset operation of sending the first register data to the BIOS, wherein the first register data is register data generated by a register, which simulates the external device, in response to second error information; S2, acquiring a first log and/or a second log reported by the BIOS, where the first log is a log obtained by the BIOS parsing second register data, the second register data is register data generated by the register in response to the first error information, and the second log is a log obtained by the BIOS parsing the first register data; and S3, determining a running state of the external device according to the first log and standard register data corresponding to the first error information, and/or determining a running state of the BIOS according to the second log and a standard log corresponding to the first register data, where the running state is a fault state or a normal state.

In some exemplary embodiments, before the S1, the method further includes: in a case where the BIOS is started, acquiring flag bit information of the BIOS, where the flag bit information is information representing a running environment of the BIOS; in a case where the flag bit information is a target flag bit, determining that the running environment of the BIOS is a development environment; and in a case where the flag bit information is not the target flag bit, determining that the running environment of the BIOS is a non-development environment.

In some exemplary embodiments, the S1 includes: in a case where the running environment of the BIOS is the development environment, executing the preset operation according to the target information.

In some exemplary embodiments, in a case where the running environment of the BIOS is the non-development environment, the method further includes: continuously simulating the generation of third error information of the external device by using an error injection tool; after an accumulated number of the third error information reaches a preset threshold defined by an error suppression function of the BIOS, determining whether a new error log exists in a BMC log; in a case where the new error log exists in the BMC log, determining that the external device does not pass a test; and in a case where the new error log does not exist in the BMC log, determining that the external device passes the test.

In some exemplary embodiments, the S1 includes at least one of the following: calling a first test case including the first error information and the standard register data from a first test case library, and executing the preset operation of injecting the first error information into the external device according to the first test case, where the first test case library includes a plurality of first test cases, and different first test cases correspond to different first error information; calling a second test case including the first register data and the standard log from a second test case library, and executing the preset operation of sending the second register data to the BIOS according to the second test case, where the second test case library includes a plurality of second test cases, and different second test cases correspond to different first register data.

In some exemplary embodiments, before the S3, the method further includes: calling the first test case to obtain the standard register data corresponding to the first error information, and/or calling the second test case to obtain the standard log corresponding to the first register data.

In some exemplary embodiments, after the S3, the method further includes: S4, calling a new first test case from the first test case library, and/or calling a new second test case from the second test case library; and a repeating step, repeatedly executing the S4, the S1, the S2, and the S3 for a predetermined number of times until all the first test cases are called from the first test case library and/or all the second test cases are called from the second test case library.

In some exemplary embodiments, after the repeating step, the method further includes at least one of the following: generating a first test report according to the running state of the external device and the corresponding standard register data, and sending the first test report to a display terminal to cause the display terminal to display the first test report; generating a second test report according to the running state of the BIOS and the corresponding first register data, and sending the second test report to the display terminal to cause the display terminal to display the second test report.

In some exemplary embodiments, the first test case further includes an injection manner of the first error information.

In some exemplary embodiments, the operation of executing the preset operation of injecting the first error information into the external device includes: remotely logging in to an OS of the external device; and in a case of remotely logging in to the OS of the external device, controlling an error injection tool to inject the first error information into a port of the external device.

In some exemplary embodiments, the operation of executing the preset operation of sending the second register data to the BIOS comprises: remotely logging in to the BIOS; in a case of remotely logging in to the BIOS, generating an interrupt instruction carrying the second register data; and sending the interrupt instruction to the BIOS, to cause the BIOS, in response to the interrupt instruction to perform fault information processing on the external device to generate the second log.

In some exemplary embodiments, the operation of remotely logging into the BIOS includes: logging in to the BIOS through a Struts, Spring, Hibernate or SpringMVC, Spring, Hibernat (SSH) channel.

In some exemplary embodiments, the operation of determining the running state of the external device according to the first log and the standard register data corresponding to the first error information includes: extracting the second register data from the first log; in a case where the second register data is different from the standard register data, determining that the running state of the external device is the fault state; and in a case where the second register data is the same as the standard register data, determining that the running state of the external device is the normal state.

In some exemplary embodiments, the operation of determining the running state of the BIOS according to the second log and the standard log corresponding to the first register data includes: in a case where the second log is different from the standard log, determining that the running state of the BIOS is the fault state; and in a case where the second log is the same as the standard log, determining that the running state of the BIOS is the normal state.

In some exemplary embodiments, the operation of determining the running state of the BIOS according to the second log and the standard log corresponding to the first register data includes: extracting actual location information of the external device where a fault occurs and actual register data corresponding to the external device where the fault occurs from the second log; extracting standard error location information from the standard log; in a case where the actual location information is different from the standard error location information, or the actual register data is different from the first register data, determining that the running state of the BIOS is the fault state; and in a case where the actual location information is the same as the standard error location information, and the actual register data is the same as the first register data, determining that the running state of the BIOS is the normal state.

In some exemplary embodiments, the external device invludes a PCIe device.

According to another optional embodiment of the present application, an apparatus of detecting a fault for an external device is provided. The external device is in communication connection with a BIOS. The apparatus includes: an execution unit, configured to execute a preset operation according to target information, wherein the execution unit is configured to execute the preset operation according to the target information by following steps: in a case where the target information includes first error information, executing the preset operation of injecting the first error information into the external device, and in a case where the target information includes first register data, executing the preset operation of sending the first register data to the BIOS, and the first register data is register data generated by a register, which simulates the external device, in response to second error information; a first acquisition unit, configured to acquire a first log and/or a second log reported by the BIOS, where the first log is a log obtained by the BIOS parsing second register data, the second register data is register data generated by the register in response to the first error information, and the second log is a log obtained by the BIOS parsing the first register data; and a first determination unit, configured to determine a running state of the external device according to the first log and standard register data corresponding to the first error information, and/or determine a running state of the BIOS according to the second log and a standard log corresponding to the first register data, where the running state is a fault state or a normal state.

According to still another optional embodiment of the present application, a non-volatile computer readable storage medium is further provided, in which a computer program is stored. The computer program is configured to execute steps of any one of the above method embodiments when running.

According to still another optional embodiment of the present application, a processor is further provided. The processor is configured to run a program, and the program executes steps of any one of the above methods when the program is run.

According to another optional embodiment of the present application, a system of detecting a fault for a server is further provided, which includes a PCIe device; a BIOS, which is in communication connection with the PCIe device, and is configured to perform fault information processing on the PCIe device to generate a log; and a test device, including a memory and a processor. A computer program is stored in the memory and executable on the processor, and the processor is configured to run the computer program to execute steps in any one of the above method embodiments to detect a running state of the PCIe device, and/or, a running status of the BIOS.

In some exemplary embodiments, the server further includes: a BMC, which is in communication with the BIOS further configured to send the log to the BMC, and is configured to generate a BMC log according to the log.

Through the present application, the decoupling of fault detection of the external device and the BIOS is achieved, that is, in the process of detecting the external device, if it is necessary to detect whether the fault occurs in the external device, it is only necessary to inject the first error information into the external device, acquire the first log reported by the BIOS, and determine according to the first log and the standard register data, and if it is necessary to detect whether the fault occurs in the BIOS, it is only necessary to send the first register data to the BIOS, acquire the second log reported by the BIOS, and determine according to the second log and the standard log, thereby achieving the effect of accurately locating whether the error location is the BIOS or the external device itself, effectively solving the problem in the related art that the fault point cannot be effectively located by the fault location solution of the external device, reducing the coupling between the faults in a fault testing process, and improving the efficiency and reliability of the fault processing flow of the external device.

### BRIEF DESCRIPTION OF THE DRAWINGS

FIG. 1 shows a block diagram of a hardware structure of a mobile terminal for a method of detecting a fault for an external device according to an embodiment of the present application.

FIG. 2 is a flowchart of a method of detecting a fault for an external device according to an embodiment of the present application.

FIG. 3 is a flowchart of a method of detecting a fault for an external device according to an embodiment of the present application.

FIG. 4 is a flowchart of another method of detecting a fault for an external device according to an embodiment of the present application.

FIG. 5 is a flowchart of still another method of detecting a fault for an external device according to an embodiment of the present application.

FIG. 6 is a structural block diagram of an apparatus of detecting a fault for an external device according to an embodiment of the present application.

Herein, the above drawings include the following reference signs.

102. Processor; 104. Memory; 106. Transmission device; 108. Input/output device.

### DETAILED DESCRIPTION OF THE EMBODIMENTS

Embodiments of the present application are described below with reference to the drawings and in conjunction with the embodiments in detail.

It is to be noted that terms “first”, “second” and the like in the specification, claims and the drawings of the present application are used for distinguishing similar objects rather than describing a specific sequence or a precedence order.

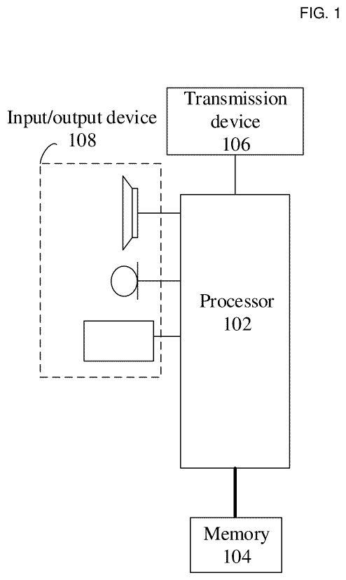

The method embodiment provided by the embodiments of the present application may be implemented in a mobile terminal, a computer terminal or a similar computing apparatus. Taking running on the mobile terminal as an example, FIG. 1 is a block diagram of a hardware structure of a mobile terminal for a method of detecting a fault for an external device according to an embodiment of the present application. As shown in FIG. 1, the mobile terminal may include one or more (only one is shown in FIG. 1) processors 102 (the processors 102 may include, but are not limited to, a Micro Processor Unit (MCU) or a Field Programmable Gate Array (FPGA), and other processing apparatuses), and a memory 104 configured to store data. The mobile terminal may further include a transmission device 106 configured to achieve a communication function and an input/output device 108. Those of ordinary skill in the art may understand that the structure shown in FIG. 1 is only schematic and not intended to limit the structure of the mobile terminal. For example, the mobile terminal may further include more or fewer components than those shown in FIG. 1, or have a different configuration from that shown in FIG. 1.

The memory 104 may be configured to store a computer program, for example, a software program or a module of application software, such as a computer program corresponding to a fault detection method for an external device in the embodiments of the present application. The processor 102 runs the computer program stored in the memory 104, to execute various functional applications and data processing, that is, to implement the method. The memory 104 may include a high speed Random Access Memory (RAM) and may further include a non-volatile memory such as one or more magnetic storage apparatuses, a flash memory, or other non-volatile solid state memories. In some examples, the memory 104 may include memories remotely located relative to the processor 102, which may be connected to the mobile terminal over a network. Examples of the network include, but are not limited to, the Internet, an Intranet, a local area network, a mobile communication network, and a combination thereof.

The transmission module 106 is configured to receive or transmit data through a network. The specific example of the network may include a wireless network provided by a communication provider of the mobile terminal. In one example, the transmission device 106 includes a Network Interface Controller (NIC) that may be connected to other network devices through a base station to communicate with the Internet. In one example, the transmission device 106 may be a Radio Frequency (RF) module, which is configured to communicate with the Internet in a wireless manner.

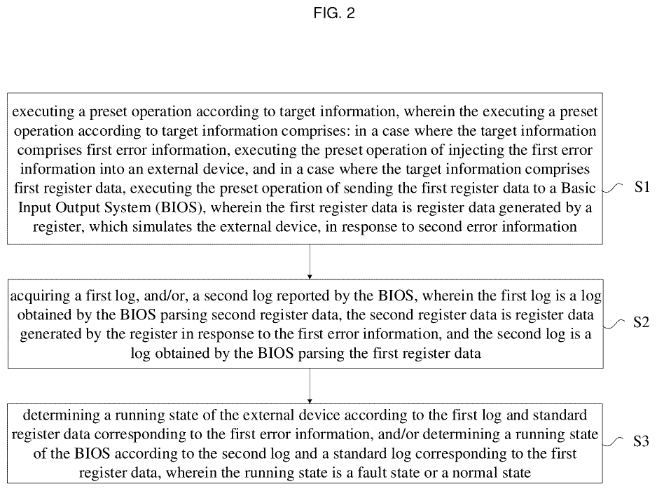

In the embodiments of the present application, a method of detecting a fault for an external device running on a mobile terminal is provided. The external device is in communication connection with a BIOS. FIG. 2 is a flowchart of a method of detecting a fault for an external device according to an embodiment of the present application. As shown in FIG. 2, the flow includes the following steps.

At S1, executing a preset operation according to target information, wherein the executing a preset operation according to target information includes: in a case where the target information includes first error information, executing the preset operation of injecting the first error information into the external device (namely, the operation of injecting the first error information into the external device can be or include an operation of transmitting the first error information to the external device), and in a case where the target information includes first register data, executing the preset operation of sending the first register data to the BIOS, wherein the first register data is register data generated by a register, which simulates the external device, in response to second error information.

Optionally, the target information may include only the first error information, or only the first register data, or the first error information and the first register data. The first error information and the second error information are error data that do not conform to the code running logic. The first error information and the second error information may be obtained from a case database formed by extracting and summarizing historical fault cases, or from error data that may be theoretically inferred to have an error. Under normal circumstances, when the error occurs in the external device, the register of the external device may respond to the error information to generate the register data reflecting the error information. The first register data in the present application is the data obtained by simulating the register data generated by the register normally responding to the second error information. Similarly, the first register data may also be obtained from the case database formed by extracting and summarizing the historical fault cases, or from the register data corresponding to the error data that may be theoretically inferred to have the error.

At S2, acquiring a first log, and/or, a second log reported by the BIOS, wherein the first log is a log obtained by the BIOS parsing second register data, the second register data is register data generated by the register in response to the first error information, and the second log is a log obtained by the BIOS parsing the first register data.

Optionally, in a case where the preset operation of injecting the first error information into the external device (namely, the operation of injecting the first error information into the external device can be or include an operation of transmitting the first error information to the external device) is executed, the first log reported by the BIOS is acquired. In a case where the preset operation of sending the first register data to the BIOS is executed, the second log reported by the BIOS is acquired. The second register data is real register data generated by the register responding to the first error information. The BIOS transmits data and executes instructions through the register, and the BIOS parses the corresponding register data to obtain information about the external device where the error occurs and error source information, generates a log with the register data, the information about the external device where the error occurs, and the error source information, and reports the log to the BMC or the OS. The error source information includes an error type of the external device, such as a repairable error and an unrepairable error, and the information about the external device where the error occurs specifically includes location information of the external device where the error occurs.

At S3, determining a running state of the external device is determined according to the first log and standard register data corresponding to the first error information, and/or, a running state of the BIOS is determined according to the second log and a standard log corresponding to the first register data. The running state is a fault state or a normal state.

Optionally, the standard register data is the register data generated by the register responding to the first error information in a normal case. The standard log is a log obtained by the BIOS processing according to an error processing flow in a normal case and parsing the first register data. In a specific application, log information of the first log and the second log may be viewed by calling a log viewing tool.

Through the steps, firstly, the first error information is injected into the external device, and/or, the first register data generated by the simulated register responding to the second error information is sent to the BIOS; then, the first log obtained by the BIOS parsing the second register data is acquired, where the second register data is the data generated by the register responding to the first error information, and/or, the second log obtained by the BIOS parsing the first register data is acquired; and finally, it is determined whether the external device is in the normal running state according to the first log and the standard register data, and/or, it is determined whether the BIOS is in the normal running state according to the second log and the standard log, so that the decoupling of fault detection of the external device and the BIOS is achieved, that is, in the process of detecting the external device, if it is necessary to detect whether the fault occurs in the external device, it is only necessary to inject the first error information into the external device, acquire the first log reported by the BIOS, and determine according to the first log and the standard register data, and if it is necessary to detect whether the fault occurs in the BIOS, it is only necessary to send the first register data to the BIOS, acquire the second log reported by the BIOS, and determine according to the second log and the standard log, thereby achieving the effect of accurately locating whether the error location is the BIOS or the external device itself, effectively solving the problem in the related art that the fault point cannot be effectively located by the fault location solution of the external device, reducing the coupling between the faults in a fault testing process, and improving the efficiency and reliability of the fault processing flow of the external device.

It is to be noted that the running state of the external device is the running state of the register of the external device, specifically whether the register may normally respond to the error information of the external device.

In the present application, a result of determining the running state of the register does not depend on results of whether the version of an error injection tool is matched, whether the BIOS configuration before the error injection is correct, whether the error injection operation is correct, etc. Similarly, in the present application, the result of determining the running state of the register does not depend on the running state of the register, which achieves the decoupling of the fault processing flow of the external device. There is no uncertainty in the entire processing flow, and the fault location can be accurately located, which may achieve a better detection effect.

Optionally, a register data structure may be created in a Non-Volatile Random Access Memory (NVRAM) area stored in the BIOS, and each value in the first register data structure may be set according to the actual historical fault cases to obtain the first register data.

The execution subject of the steps may be a terminal, etc., but is not limited thereto.

In some exemplary embodiments, before S1, the method further includes: in a case where the BIOS is started, acquiring flag bit information of the BIOS, wherein the flag bit information is information representing a running environment of the BIOS; in a case where the flag bit information is a target flag bit, determining that the running environment of the BIOS is a development environment; and in a case where the flag bit information is not the target flag bit, determining that the running environment of the BIOS is a non-development environment. Before the fault detection is performed on the external device, the running environment of the BIOS is first determined, and then a fault detection solution is performed according to the running environment.

On this basis, S1 includes: in a case where the running environment of the BIOS is the development environment, executing the preset operation according to the target information. That is, the present application is a solution for performing fault detection on the external device in the development environment.

Optionally, the target flag bit may be any flag bit information. The BIOS is configured to initialize the external device, including detecting whether the external device works normally, and performing configuration and initialization on the external device. After the external device is initialized, the BIOS may perform a self-test, including detecting system information, checking hardware devices, and executing OS startup.

According to some other embodiments, in a case where the running environment of the BIOS is the non-development environment, the method further includes: continuously simulating the generation of third error information of the external device by using the error injection tool; after an accumulated number of the third error information reaches a preset threshold defined by an error suppression function of the BIOS, determining whether a new error log exists in a BMC log; in a case where the new error log exists in the BMC log, determining that the external device does not pass a test; and in a case where the new error log does not exist in the BMC log, determining that the external device passes the test. In the non-development environment, the preset threshold of an error suppression function item of the external device is parsed from a BIOS configuration file, and the preset threshold is a trigger value of the error suppression function of the BIOS. When the accumulated number of the third error information of the external device reaches the trigger value, the BIOS no longer reports the third error information of the external device to the BMC.

Optionally, the third error information is correctable error information of the external device. The preset threshold may be located from the BIOS configuration file by using a keyword search function, then the number of all the third error information of the external device currently being simulated is counted by using a counter, and when the number reaches the preset threshold, the log viewing tool is called to collect the BMC log and filter the new error log from the BMC log. The new error log refers to an error log generated by the BMC after the number of all the third error information of the external device reaches the preset threshold. Since the preset threshold is the trigger value of the error suppression function of the external device, the expected effect should be that the error suppression function of the BIOS has taken effect and there is no new error log in the BMC log. Therefore, if the log viewing tool does not filter out the new error log from the BMC log, it indicates that the error suppression function of the BIOS has taken effect, otherwise it indicates that the error suppression function of the BIOS has not taken effect and needs to be reset.

In some exemplary embodiments, S1 includes at least one of the following:

At S1011, calling a first test case including the first error information and the standard register data is called from a first test case library, and the preset operation of injecting the first error information into the external device (namely, the operation of injecting the first error information into the external device can be or include an operation of transmitting the first error information to the external device) is executed according to the first test case. The first test case library includes a plurality of first test cases, and different first test cases correspond to different first error information.

Optionally, in the first test case library, different first test cases correspond to testing different types of errors of the external device, and when the first error information is different, the corresponding standard register data is also different. In addition to the first error information and the standard register data, those skilled in the art may add the information required in a fault detection process of the external device to the first test case according to actual needs. For example, the first test case may further include an injection manner of the first error information. For another example, the first test case may further include information such as version information of the error injection tool.

At S1012, calling a second test case including the first register data and the standard log is called from a second test case library, and the preset operation of sending the second register data to the BIOS is executed according to the second test case. The second test case library includes a plurality of second test cases, and different second test cases correspond to different first register data.

Optionally, in the second test case library, different second test cases correspond to testing different types of errors of the BIOS, and when the first register data is different, the corresponding standard log is also different.

In an optional embodiment, the first error information required for testing the running state of the external device and the corresponding standard register data are stored in the first test case library in the form of test cases. When testing is needed, only the corresponding first test case needs to be called. Similarly, the first register data required for testing the running state of the BIOS and the corresponding standard log are stored in the second test case library in the form of test cases. When testing is needed, only the corresponding second test case needs to be called, so that the test flow is further simplified and the test efficiency of the fault test of the external device is improved.

In the embodiments of the present application, before S3, the method further includes: calling the first test case to obtain the standard register data corresponding to the first error information, and/or, calling the second test case to obtain the standard log corresponding to the first register data.

In another optional solution, after S3, the method further includes: S4, calling a new first test case from the first test case library, and/or, calling a new second test case from the second test case library; and a repeating step, repeatedly executing the S4, the S1, the S2, and the S3 for a predetermined number of times until all the first test cases are called from the first test case library, and/or, all the second test cases are called from the second test case library. Through the circulation step, the processing flows of different types of errors of the external device are sequentially detected, thereby achieving complete fault detection of the external device and effective filtering of the external device with the error processing flow, and/or the processing flows of different types of errors of the BIOS are sequentially detected, thereby achieving complete fault detection of the BIOS and effective filtering of the BIOS with the error processing flow.

In order to further facilitate the relevant personnel to know and view a test result, according to some exemplary embodiments of the present application, after the circulation step, the method further includes at least one of the following: generating a first test report according to the running state of the external device and the corresponding standard register data, and sending the first test report to a display terminal to cause the display terminal to display the first test report; and generating a second test report according to the running state of the BIOS and the corresponding first register data, and sending the second test report to the display terminal to cause the display terminal to display the second test report. In the present embodiment, the corresponding test report is generated according to the fault detection result and sent to the display terminal for display, which facilitates the relevant personnel to know the test result, and at the same time facilitates the relevant personnel to process the external device or the BIOS where the fault occurs in a timely manner according to the test result.

In some exemplary embodiments, the operation of executing the preset operation of injecting the first error information into the external device (namely, the operation of injecting the first error information into the external device can be or include an operation of transmitting the first error information to the external device) includes: remotely logging in to an OS of the external device; and in a case of remotely logging in to the OS of the external device, controlling an error injection tool to inject the first error information into a port of the external device. By remotely logging in to the OS of the external device, communication with the external device is achieved, and then the first error information is injected into the port of the external device through the error injection tool, which ensures that error injection may be performed on the external device a relatively simple and quick manner.

In the actual application process, the error injection tool is generally connected to the port in the form of an error injection card. An optional implementation for remotely logging in to the OS of the external device may be: logging in to the OS of the external device through an SSH channel. Remote communication with the external device is performed through the SSH channel, and an SSH protocol has good reliability and security, so that the communication security of remote communication is ensured. In addition, the SSH protocol has strong applicability and may be implemented on almost all platforms.

Of course, in addition to the SSH communication mode, the terminal for the method of detecting a fault running in the present application may also establish a communication relationship with the external device through other communication modes, such as a Telecommunication Network (Telnet) (a remote terminal protocol) and a Virtual Network Computing (VNC) protocol.

In order to further simply and quickly acquire the second log to facilitate subsequent fault detection of the BIOS, according to some other optional embodiments of the present application, the preset operation of sending the second register data to the BIOS is executed, which includes: remotely logging in to the BIOS; in a case of remotely logging in to the BIOS, generating an interrupt instruction carrying the second register data; and sending the interrupt instruction to the BIOS, to cause the BIOS, in response to the interrupt instruction to perform fault information processing on the external device to generate the second log. By remotely logging in to the BIOS, communication with the BIOS is achieved, and then the interrupt instruction carrying the second register data is sent to the BIOS, which further ensures that fault detection may be performed on the BIOS in a relatively simple and quick manner.

In some exemplary embodiments, the operation of remotely logging in to the BIOS includes: logging into the BIOS through an SSH channel. Remote communication with the BIOS is performed through the SSH channel, and the SSH protocol has good reliability and security, so that the communication security of remote communication is ensured. In addition, the SSH protocol has strong applicability and may be implemented on almost all platforms.

Optionally, in S3, the specific process of determining a running state of the external device according to the first log and standard register data corresponding to the first error information may be: extracting the second register data from the first log; in a case where the second register data is different from the standard register data, determining that the running state of the external device is the fault state; and in a case where the second register data is the same as the standard register data, determining that the running state of the external device is the normal state. In the present embodiment, the second register data is obtained from the log obtained by the second register data generated by the BIOS responding to the first error information, and the second register data is compared with the standard register data corresponding to the first error information. If the two are the same, it indicates that the register is normal, that is, it indicates that the external device itself is in the normal state, otherwise it indicates that the external device is in the fault state.

Optionally, the second register data is actual register data generated by the register responding to the first error information. In addition to the error source information, the register data, and the information about the external device where the error occurs, the first log and the second log further include information such as a hardware slot number and the number of reported logs.

In one optional embodiment, in S3, the operation of determining the running state of the BIOS according to the second log and the standard log corresponding to the first register data includes: in a case where the second log is different from the standard log, determining that the running state of the BIOS is the fault state; and in a case where the second log is the same as the standard log, determining that the running state of the BIOS is the normal state. In the present embodiment, the second log is directly compared with the standard log to determine whether the BIOS is in the fault state, which may further ensure that the accuracy of BIOS fault diagnosis is relatively high.

In addition to the above manner, in order to further simplify the fault detection process and further improve the fault detection and processing efficiency, in some exemplary embodiments, the operation of determining a running state of the BIOS according to the second log and a standard log corresponding to the first register data includes: extracting actual location information of the external device where a fault occurs and actual register data corresponding to the external device where the fault occurs from the second log; extracting standard error location information from the standard log; in a case where the actual location information is different from the standard error location information, or the actual register data is different from the first register data, determining that the running state of the BIOS is the fault state; and in a case where the actual location information is the same as the standard error location information, and the actual register data is the same as the first register data, determining that the running state of the BIOS is the normal state. The present embodiment only compares whether the register data and the error location information in the second log and the standard log are the same, and the comparison information is less, thereby further ensuring that the comparison process may be completed relatively quickly.

Optionally, the error location information may specifically be an address of the external device. The actual register data is the register data recorded in the log reported by the BIOS.

In addition, the first log and the second log of the BIOS may be sent to the BMC or the OS. S2 may be specifically implemented in the following manners: acquiring the first log and/or the second log sent by the BIOS to the BMC by sending a redfish (a RESTful-based protocol, and a standard for managing and monitoring a hardware device) instruction; and logging in to the OS through the SSH channel, and inputting a dmesg command (a program for displaying the latest information in a kernel ring buffer) to acquire the first log and/or the second log in the OS.

In the present application, the external device may include any hardware device, such as a CPU, a memory, a hard disk, a keyboard, a PCIe, etc. In one optional embodiment, the external device includes a PCIe device. In one optional embodiment, the external device is the PCIe device.

Through the above description of implementations, those skilled in the art may clearly know that the method according to the embodiments may be implemented by means of software plus a necessary common hardware platform, certainly by means of hardware; but in many cases, the former is the better implementation. Based on such understanding, the technical solution of the present application, which is essential or contributes to the conventional art, may be embodied in the form of a software product. The computer software product is stored in a non-volatile readable storage medium (such as a Read-Only Memory (ROM)/Random Access Memory (RAM), a magnetic disk and an optical disc), including a number of instructions for causing a terminal device (which may be a mobile phone, a computer, a server, or a network device, etc.) to perform the methods described in various embodiments of the present application.

In order to enable those skilled in the art to more clearly understand the technical solutions of the present application, the implementation process of a method of detecting a fault for an external device of the present application will be described in detail below in conjunction with specific embodiments.

The present embodiment relates to a method of detecting a fault for an external device, where the external device is a PCIe. The method of detecting a fault of the present application is applied to a test machine, and the method includes the following two parts of steps.

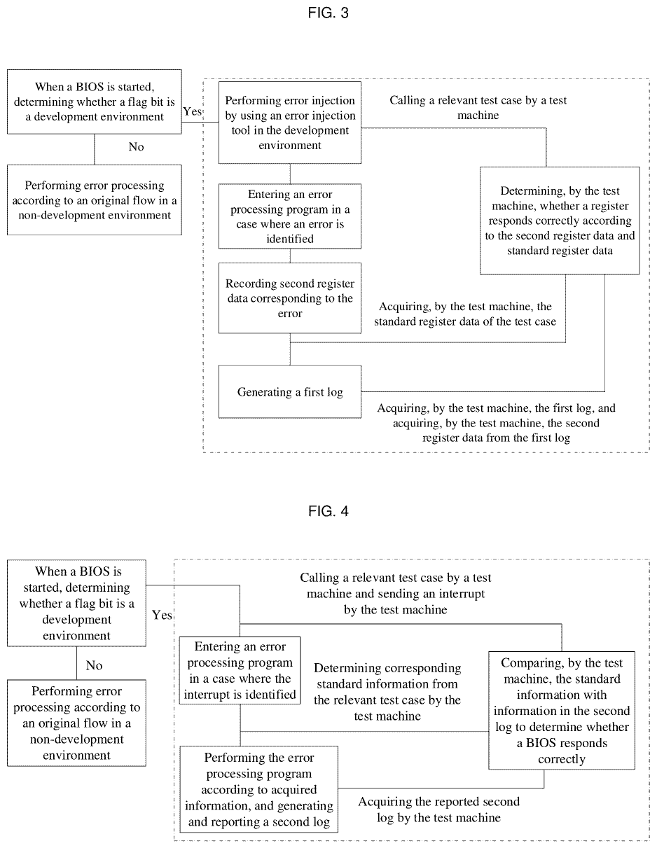

Part 1: As shown in FIG. 3, it is checked whether the PCIe device itself responds correctly, that is, it is checked whether a register responds correctly.

At S11, in a BIOS startup process of a tested machine, determining whether the tested machine is in a development environment according to a flag bit, and if the tested machine is in the development environment, the following flow is executed, otherwise a PCIe fault is detected according to an original detection flow.

At S12, the test machine runs a test script to call one of first test cases, and according to the first test case, the test machine uses a fault injection tool to perform specific error injection on the PCIe device on a BIOS of the tested machine in a specific communication manner (including, but is not limited to, SSH communication).

At S13, a register fault processing function of the PCIe device identifies injected first error information and generates second register data, and the BIOS performs an error processing flow according to the second register data to generate a first log and report same to a BMC or an OS.

At S14, the test machine acquires the first log, extracts the second register data from the first log, reads standard register data corresponding to the first error information from the first test case, and compares the second register data with the standard register data to confirm test results. If the test results are the same, it is determined that the register is normal, otherwise it is determined that the register is faulty.

At S15, the test machine issues a test instruction for the next first test case, and summarizes the test results after all the tests are completed.

Part 2: As shown in FIG. 4, it is checked whether a BIOS responds correctly.

At S16, in the BIOS startup process of the tested machine, determining whether the tested machine is in the development environment according to the flag bit, and if the tested machine is in the development environment, the following flow is executed, otherwise the PCIe fault is detected according to the original detection flow.

At S17, the test machine runs the test script to call one of second test cases, and according to the second test case, the test machine sends an interrupt to the BIOS of the tested machine in a specific communication manner (including, but is not limited to, using SSH communication), where the interrupt carries first register data, and the BIOS of the tested machine enters an error processing program.

At S18, the BIOS of the tested machine processes the fault of the PCIe device according to the assumed first register data to generate a second log and report same to the OS or the BMC.

At S19, acquiring the second log by the test machin, extracts location information of the faulty PCIe device and actual register data from the second log, extracts a standard error location and the first register data from the second test case, compares the first register data with the actual register data, compares the location information of the faulty PCIe device with the standard error location, and confirms test results. If the test results are the same, it is determined that the BIOS is normal, otherwise it is determined that the BIOS is faulty.

At S20, the test machine issues a test instruction for the next second test case, and summarizes the test results after all the tests are completed.

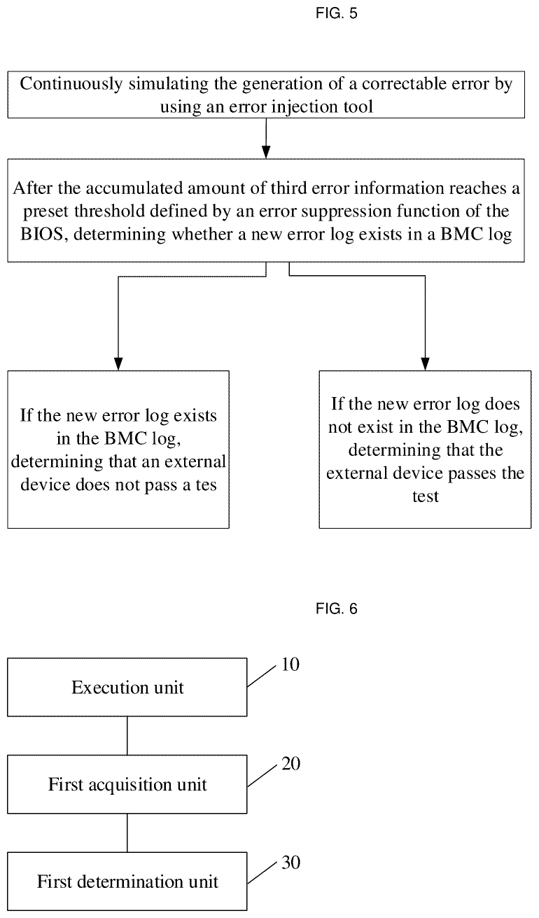

In addition, in a non-development environment, the process of detecting the PCIe fault according to the original detection flow is shown in FIG. 5, and the details are as follows.

At S21, continuously simulating the generation of a correctable error by using an error injection tool, i.e., third error information.

At S22, after the number of correctable errors (stored in one register) is compared with a threshold (stored in another register), a BMC log is checked to determine whether the function passes a test.

At S23, in a case where a new error log exists in the BMC log, determining that an external device does not pass the test, and in a case where the new error log does not exist in the BMC log, determining that the external device passes the test.

In the present embodiment, an apparatus of detecting a fault for an external device is further provided, the external device is in communication connection with a BIOS, and the apparatus is configured to implement the embodiments and optional implementations, which have been described and will not be elaborated. The term “module” used below may realize a combination of software and/or hardware with a predetermined function. Although the apparatus described in the following embodiment is preferably realized by software, but by hardware or a combination of software and hardware is also possible and conceived.

FIG. 6 is a structural block diagram of an apparatus of detecting a fault for an external device according to an embodiment of the present application. As shown in FIG. 6, the apparatus includes:

An execution unit 10 is configured to execute a preset operation according to target information, wherein the execution unit is configured to execute the preset operation according to the target information by following steps: in a case where the target information includes first error information, executing the preset operation of injecting the first error information into the external device (namely, the operation of injecting the first error information into the external device can be or include an operation of transmitting the first error information to the external device), and in a case where the target information includes first register data, executing the preset operation of sending the first register data to a BIOS, and the first register data is register data generated by a register, which simulates the external device, in response to second error information.

Optionally, the target information may include only the first error information, or only the first register data, or the first error information and the first register data. The first error information and the second error information are error data that do not conform to the code running logic. The first error information and the second error information may be obtained from a case database formed by extracting and summarizing historical fault cases, or from error data that may be theoretically inferred to have an error. Under normal circumstances, when the error occurs in the external device, the register of the external device may respond to the error information and generate the register data reflecting the error information responding. The first register data in the present application is the data obtained by simulating the register data generated by the register normally responding to the second error information. Similarly, the first register data may also be obtained from the case database formed by extracting and summarizing the historical fault cases, or from the register data corresponding to the error data that may be theoretically inferred to have the error.

A first acquisition unit 20 is configured to acquire a first log and/or a second log reported by the BIOS, where the first log is a log obtained by the BIOS parsing second register data, the second register data is register data generated by the register in response to the first error information, and the second log is a log obtained by the BIOS parsing the first register data.

Optionally, in a case where the preset operation of injecting the first error information into the external device (namely, the operation of injecting the first error information into the external device can be or include an operation of transmitting the first error information to the external device) is executed, the first log reported by the BIOS is acquired. In a case where the preset operation of sending the first register data to the BIOS is executed, the second log reported by the BIOS is acquired. The second register data is real register data generated by the register responding to the first error information. The BIOS transmits data and executes instructions through the register, and the BIOS parses the corresponding register data to obtain information about the external device where the error occurs and error source information, generates a log with the register data, the information about the external device where the error occurs, and the error source information, and reports the log to the BMC or the OS. The error source information includes an error type of the external device, such as a repairable error and an unrepairable error, and the information about the external device where the error occurs includes location information of the external device where the error occurs.

A first determination unit 30 is configured to determine a running state of the external device according to the first log and standard register data corresponding to the first error information, and/or determine a running state of the BIOS according to the second log and a standard log corresponding to the first register data. The running state is a fault state or a normal state.

Optionally, the standard register data is the register data generated by the register responding to the first error information in a normal case. The standard log is a log obtained by the BIOS processing according to an error processing flow in a normal case and parsing the first register data. In a specific application, log information of the first log and the second log may be viewed by calling a log viewing tool.

Through the solution, the execution unit injects the first error information into the external device, and/or sends the first register data generated by the simulated register responding to the second error information to the BIOS; the first acquisition unit acquires the first log obtained by the BIOS parsing the second register data, where the second register data is the data generated by the register responding to the first error information, and/or acquires the second log obtained by the BIOS parsing the first register data; the first determination unit determines whether the external device is in the normal running state according to the first log and the standard register data, and/or determines whether the BIOS is in the normal running state according to the second log and the standard log, so that the decoupling of fault detection of the external device and the BIOS is achieved, that is, in the process of detecting the external device, if it is necessary to detect whether the fault occurs in the external device, it is only necessary to inject the first error information into the external device, acquire the first log reported by the BIOS, and determine according to the first log and the standard register data, and if it is necessary to detect whether the fault occurs in the BIOS, it is only necessary to send the first register data to the BIOS, acquire the second log reported by the BIOS, and determine according to the second log and the standard log, thereby achieving the effect of accurately locating whether the error location is the BIOS or the external device itself, effectively solving the problem in the related art that the fault point cannot be effectively located by the fault location solution of the external device, reducing the coupling between the faults in a fault testing process, and improving the efficiency and reliability of the fault processing flow of the external device.

It is to be noted that the running state of the external device is the running state of the register of the external device, specifically whether the register may normally respond to the error information of the external device.

In the present application, a result of determining the running state of the register does not depend on results of whether the version of an error injection tool is matched, whether the BIOS configuration before the error injection is correct, whether the error injection operation is correct, etc. Similarly, in the present application, the result of determining the running state of the register does not depend on the running state of the register, which achieve the decoupling of the fault processing flow of the external device. There is no uncertainty in the entire processing flow, and the fault location can be accurately located, which may achieve a better detection effect.

Optionally, a register data structure may be created in an NVRAM area stored in the BIOS, and each value in the first register data structure may be set according to the actual historical fault cases to obtain the first register data.

The execution subject of the apparatus may be a terminal, etc., but is not limited thereto.

In some exemplary embodiments, the apparatus further includes: a second acquisition unit, configured to, before S1, in a case where the BIOS is started, acquire flag bit information of the BIOS, wherein the flag bit information is information representing a running environment of the BIOS; a second determination unit, configured to determine, in a case where the flag bit information is a target flag bit, that the running environment of the BIOS is a development environment; and a third determination unit, configured to determine, in a case where the flag bit information is not the target flag bit, that the running environment of the BIOS is a non-development environment. Before the fault detection is performed on the external device, the running environment of the BIOS is first determined, and then a fault detection solution is performed according to the running environment.

On this basis, the execution unit includes: an execution module, configured to execute the preset operation according to the target information in a case where the running environment of the BIOS is the development environment. That is, the present application is a solution for performing fault detection on the external device in the development environment.

Optionally, the target flag bit may be any flag bit information. The BIOS is configured to initialize the external device, specifically including detecting whether the external device works normally, and performing configuration and initialization on the external device. After the external device is initialized, the BIOS may perform a self-test, including detecting system information, checking hardware devices, and executing OS startup.

According to some other embodiments, the apparatus further includes: a first generation unit, configured to continuously simulate, in a case where the running environment of the BIOS is the non-development environment, the generation of third error information of the external device by using the error injection tool; a fourth determination unit, configured to determine, after an accumulated number of the third error information reaches a preset threshold defined by an error suppression function of the BIOS, whether a new error log exists in a BMC log; a fifth determination unit, configured to determine, in a case where the new error log exists in the BMC log, that the external device does not pass a test; and a sixth determination unit, configured to determine, in a case where the new error log does not exist in the BMC log, that the external device passes the test. In the non-development environment, the preset threshold of an error suppression function item of the external device is parsed from a BIOS configuration file, and the preset threshold is a trigger value of the error suppression function of the BIOS. When the accumulated number of the third error information of the external device reaches the trigger value, the BIOS no longer reports the third error information of the external device to the BMC.

Optionally, the third error information is correctable error information of the external device. The preset threshold may be located from the BIOS configuration file by using a keyword search function, then the number of all the third error information of the external device currently being simulated is counted by using a counter, and when the number reaches the preset threshold, the log viewing tool is called to collect the BMC log and filter the new error log from the BMC log. The new error log refers to the error log generated by the BMC after the number of all the third error information of the external device reaches the preset threshold. Since the preset threshold is the trigger value of the error suppression function of the external device, the expected effect should be that the error suppression function of the BIOS has taken effect and there is no new error log in the BMC log. Therefore, if the log viewing tool does not filter out the new error log from the BMC log, it indicates that the error suppression function of the BIOS has taken effect, otherwise it indicates that the error suppression function of the BIOS has not taken effect and needs to be reset.

In some exemplary embodiments, the execution unit includes at least one of the following:
a first calling module is configured to call a first test case including the first error information and the standard register data from a first test case library, and execute the preset operation of injecting the first error information into the external device (namely, the operation of injecting the first error information into the external device can be or include an operation of transmitting the first error information to the external device) according to the first test case. The first test case library includes a plurality of first test cases, and different first test cases correspond to different first error information;

Optionally, in the first test case library, different first test cases correspond to testing different types of errors of the external device, and when the first error information is different, the corresponding standard register data is also different. In addition to the first error information and the standard register data, those skilled in the art may add the information required in a fault detection process of the external device to the first test case according to actual needs. For example, the first test case may further include an injection manner of the first error information. For another example, the first test case may further include information such as version information of the error injection tool.

A second calling module is configured to call a second test case including the first register data and the standard log from a second test case library, and execute the preset operation of sending the second register data to the BIOS according to the second test case. The second test case library includes a plurality of second test cases, and different second test cases correspond to different first register data.

Optionally, in the second test case library, different second test cases correspond to testing different types of errors of the BIOS, and when the first register data is different, the corresponding standard log is also different.

In the embodiments of the present application, the first error information required for testing the running state of the external device and the corresponding standard register data are stored in the first test case library in the form of test cases. When testing is needed, only the corresponding first test case needs to be called. Similarly, the first register data required for testing the running state of the BIOS and the corresponding standard log are stored in the second test case library in the form of test cases. When testing is needed, only the corresponding second test case needs to be called, so that the test flow is further simplified and the test efficiency of the fault test of the external device is improved.

In the embodiments of the present application, the apparatus further includes: a first calling unit, configured to, before S3, call the first test case to obtain the standard register data corresponding to the first error information, and/or, call the second test case to obtain the standard log corresponding to the first register data.

In another optional solution, the apparatus further includes: a third calling unit, configured to, after S3, execute S4 of calling a new first test case from the first test case library, and/or, call a new second test case from the second test case library; and a circulation unit, configured to execute a repeating step, repeatedly executing the S4, the S1, the S2, and the S3 for a predetermined number of times until all the first test cases are called from the first test case library, and/or, all the second test cases are called from the second test case library. Through the circulation step, the processing flows of different types of errors of the external device are sequentially detected, thereby achieving complete fault detection of the external device and further achieving effective filtering of the external device with the error processing flow, and/or the processing flows of different types of errors of the BIOS are sequentially detected, thereby achieving complete fault detection of the BIOS and further achieving effective filtering of the BIOS with the error processing flow.

In order to further facilitate the relevant personnel to know and view the test result, according to some exemplary embodiments of the present application, the apparatus further includes at least one of the following: a second generation unit, configured to generate, after the circulation step, a first test report according to the running state of the external device and the corresponding standard register data, and send the first test report to a display terminal to cause the display terminal to display the first test report; a third generation unit, configured to generate a second test report according to the running state of the BIOS and the corresponding first register data, and send the second test report to the display terminal to cause the display terminal to display the second test report. In the present embodiment, the corresponding test report is generated according to the fault detection result and sent to the display terminal for display, which facilitates the relevant personnel to know the test result, and at the same time facilitates the relevant personnel to process the external device or the BIOS where the fault occurs in a timely manner according to the test result.

In some exemplary embodiments, the execution unit includes: a first login module, configured to remotely log in to an OS of the external device; and a control module, configured to control, in a case of remotely logging in to the OS of the external device, an error injection tool to inject the first error information into a port of the external device. By remotely logging in to the OS of the external device, communication with the external device is achieved, and then the first error information is injected into the port of the external device through the error injection tool, which further ensures that error injection may be performed on the external device a relatively simple and quick manner.

In the actual application process, the error injection tool is generally connected to the port in the form of an error injection card. The first login module includes: a first login submodule, configured to log in to the OS of the external device through an SSH channel. Remote communication with the external device is performed through the SSH channel, and an SSH protocol has good reliability and security, so that the communication security of remote communication is ensured. In addition, the SSH protocol has strong applicability and may be implemented on almost all platforms.

Of course, in addition to the SSH communication mode, the terminal for the fault detection apparatus running in the present application may also establish a communication relationship with the external device through other communication modes, such as a Telnet protocol and a VNC protocol.

In order to further simply and quickly acquire the second log to further facilitate subsequent fault detection of the BIOS, according to some other optional embodiments of the present application, the execution unit includes: a second login module, configured to remotely log in to the BIOS; a generation module, configured to generate, in a case of remotely logging in to the BIOS, an interrupt instruction carrying the second register data; and a first sending module, configured to send the interrupt instruction to the BIOS, to cause the BIOS, in response to the interrupt instruction to perform fault information processing on the external device to generate the second log. By remotely logging in to the BIOS, communication with the BIOS is achieved, and then the interrupt instruction carrying the second register data is sent to the BIOS, which further ensures that fault detection may be performed on the BIOS in a relatively simple and quick manner.

In some exemplary embodiments, the second login module includes: a second login submodule, configured to log into the BIOS through the SSH channel. Remote communication with the BIOS is performed through the SSH channel, and the SSH protocol has good reliability and security, so that the communication security of remote communication is ensured. In addition, the SSH protocol has strong applicability and may be implemented on almost all platforms.

Optionally, the first determination unit may include: a first extraction module, configured to extract the second register data from the first log; a first determination module, configured to determine, in a case where the second register data is different from the standard register data, that the running state of the external device is the fault state; and a second determination module, configured to determine, in a case where the second register data is the same as the standard register data, that the running state of the external device is the normal state. In the present embodiment, the second register data is obtained from the log obtained by the second register data generated by the BIOS responding to the first error information, and the second register data is compared with the standard register data corresponding to the first error information. If the two are the same, it indicates that the register is normal, that is, it indicates that the external device itself is in the normal state, otherwise it indicates that the external device is in the fault state.

Optionally, the second register data is actual register data generated by the register responding to the first error information. In addition to the error source information, the register data, and the information about the external device where the error occurs, the first log and the second log further include information such as a hardware slot number and the number of reported logs.

In one optional embodiment, the first determination module includes: a third determination module, configured to determine, in a case where the second log is different from the standard log, that the running state of the BIOS is the fault state; and a four determination module, configured to determine, in a case where the second log is the same as the standard log, that the running state of the BIOS is the normal state. In the present embodiment, the second log is directly compared with the standard log to determine whether the BIOS is in the fault state, which may further ensure that the accuracy of BIOS fault diagnosis is relatively high.

In addition to the above manner, in order to further simplify the fault detection process and further improve the fault detection and processing efficiency, in some exemplary embodiments, the first determination unit includes: a second extraction module, configured to extract actual location information of the external device where a fault occurs and actual register data corresponding to the external device where the fault occurs from the second log; a third extraction module, configured to extract standard error location information from the standard log; a fifth determination module, configured to determine, in a case where the actual location information is different from the standard error location information, or the actual register data is different from the first register data, that the running state of the BIOS is the fault state; and a sixth determination module, configured to determine, in a case where the actual location information is the same as the standard error location information, and the actual register data is the same as the first register data, that the running state of the BIOS is the normal state. The present embodiment only compares whether the register data and the error location information in the second log and the standard log are the same, and the comparison information is less, thereby further ensuring that the comparison process may be completed relatively quickly.

Optionally, the error location information may specifically be an address of the external device. The actual register data is the register data recorded in the log reported by the BIOS.

In addition, the first log and the second log of the BIOS may be sent to the BMC or the OS. The first acquisition unit includes at least one of the following: a second sending module, configured to send the first log and/or the second log sent by the BIOS to the BMC by sending a redfish instruction; and a third login module, configured to log in to the OS through the SSH channel, and input a dmesg command to acquire the first log and/or the second log in the OS.

In the present application, the external device may include any hardware device, such as a CPU, a memory, a hard disk, a keyboard, a PCIe, etc. In one optional embodiment, the external device includes a PCIe device. In one optional embodiment, the external device is the PCIe device.

It is to be noted that, each of the above modules may be implemented by software or hardware. For the latter, each of the above modules may be implemented by, but is not limited to, the following manners: the above modules are all located in the same processor; or the above modules are located in different processors in any combination.

The embodiments of the present application further provide a non-volatile computer readable storage medium, in which a computer program is stored. The computer program is configured to execute steps in any one of the above method embodiments when running.

In some exemplary embodiments, the computer non-volatile computer readable storage medium may include, but is not limited to, a U disk, an ROM, an RAM, a mobile hard disk, a magnetic disk, a compact disc, and other non-volatile readable storage media capable of storing the computer program.

The embodiments of the present application further provide an electronic device, which includes a memory and a processor. A computer program is stored in the memory, and the processor is configured to run the computer program to execute steps in any one of the above method embodiments.

In some exemplary embodiments, the electronic device may further include a transmission device and an input/output device. The transmission device is connected to the processor, and the input/output device is connected to the processor.

The embodiments of the present application further provide a system of detecting a fault for a server. The fault detection system includes a PCIe device; a BIOS, which is in communication connection with the PCIe device, and is configured to perform fault information processing on the PCIe device to generate a log; and a test device, including a memory, a processor, where a computer program is stored in the memory and executable on the processor, and the processor is configured to run the computer program to execute the steps in any one of the above method embodiments to detect a running state of the PCIe device, and/or, a running status of the BIOS.

In some exemplary embodiments, the server further includes: a BMC, which is in communication with the BIOS further configured to send the log to the BMC, and is configured to generate a BMC log according to the log.

The specific examples in this embodiment may refer to the examples described in the embodiments and the exemplary implementations, which will not be elaborated herein.

It is apparent that those skilled in the art should understand that the above modules and steps of the present application may be implemented by a general-purpose computing apparatus, and may also be gathered together on a single computing apparatus or distributed in a network composed of a plurality of computing apparatuses. The above modules or steps of the present application may be implemented with program codes executable by the computing apparatus, so that they may be stored in a storage apparatus for execution by the computing apparatus, and in some cases, the steps shown or described may be executed in an order different from that described here, or may be fabricated into individual integrated circuit modules respectively, or a plurality of modules or steps thereof are fabricated into a single integrated circuit module for implementation. In this way, the present application is not limited to any particular combination of hardware and software.

The above are only the preferred embodiments of the present application, and are not intended to limit the present application, and for those of ordinary skill in the art, various modifications and changes may be made to the present application. Any modifications, equivalent substitutions, improvements and the like made within the principle of the present application shall fall within the scope of protection of the present application.

1. A method of detecting a fault for an external device, the external device being in communication connection with a Basic Input Output System (BIOS), wherein the method comprises:
S1, executing a preset operation according to target information, wherein the executing a preset operation according to target information comprises: in a case where the target information comprises first error information, executing the preset operation of injecting the first error information into the external device, and in a case where the target information comprises first register data, executing the preset operation of sending the first register data to the BIOS, wherein the first register data is register data generated by a register, which simulates the external device, in response to second error information;
S2, acquiring a first log, and/or, a second log reported by the BIOS, wherein the first log is a log obtained by the BIOS parsing second register data, the second register data is register data generated by the register in response to the first error information, and the second log is a log obtained by the BIOS parsing the first register data; and
S3, determining a running state of the external device according to the first log and standard register data corresponding to the first error information, and/or, determining a running state of the BIOS according to the second log and a standard log corresponding to the first register data, wherein the running state is a fault state or a normal state.

2. The method according to claim 1, wherein before the S1, the method further comprises:
in a case where the BIOS is started, acquiring flag bit information of the BIOS, wherein the flag bit information is information representing a running environment of the BIOS;
in a case where the flag bit information is a target flag bit, determining that the running environment of the BIOS is a development environment; and
in a case where the flag bit information is not the target flag bit, determining that the running environment of the BIOS is a non-development environment.

3. The method according to claim 2, wherein the S1 comprises:
in a case where the running environment of the BIOS is the development environment, executing the preset operation according to the target information.

4. The method according to claim 2, wherein in a case where the running environment of the BIOS is the non-development environment, the method further comprises:
continuously simulating the generation of third error information of the external device by using an error injection tool;
after an accumulated number of the third error information reaches a preset threshold defined by an error suppression function of the BIOS, determining whether a new error log exists in a Baseboard Management Controller (BMC) log;
in a case where the new error log exists in the BMC log, determining that the external device does not pass a test; and
in a case where the new error log does not exist in the BMC log, determining that the external device passes the test.

5. The method according to claim 1, wherein the S1 comprises at least one of the following:
calling a first test case comprising the first error information and the standard register data from a first test case library, and executing the preset operation of injecting the first error information into the external device according to the first test case, wherein the first test case library comprises a plurality of first test cases, and different first test cases correspond to different first error information;
calling a second test case comprising the first register data and the standard log from a second test case library, and executing the preset operation of sending the second register data to the BIOS according to the second test case, wherein the second test case library comprises a plurality of second test cases, and different second test cases correspond to different first register data.

6. The method according to claim 5, wherein before the S3, the method further comprises: calling the first test case to obtain the standard register data corresponding to the first error information, and/or, calling the second test case to obtain the standard log corresponding to the first register data.

7. The method according to claim 5, wherein after the S3, the method further comprises:
S4, calling a new first test case from the first test case library, and/or, calling a new second test case from the second test case library; and
a repeating step, repeatedly executing the S4, the S1, the S2, and the S3 for a predetermined number of times until all the first test cases are called from the first test case library, and/or, all the second test cases are called from the second test case library.

8. The method according to claim 7, wherein after the repeating step, the method further comprises at least one of the following:
generating a first test report according to the running state of the external device and the corresponding standard register data, and sending the first test report to a display terminal to cause the display terminal to display the first test report;
generating a second test report according to the running state of the BIOS and the corresponding first register data, and sending the second test report to the display terminal to cause the display terminal to display the second test report.

9. The method according to claim 5, wherein the first test case further comprises an injection manner of the first error information.

10. The method according to claim 1, wherein the executing the preset operation of injecting the first error information into the external device comprises:
remotely logging in to an Operating System (OS) of the external device; and
in a case of remotely logging in to the OS of the external device, controlling an error injection tool to inject the first error information into a port of the external device.

11. The method according to claim 1, wherein the executing the preset operation of sending the second register data to the BIOS comprises:
remotely logging in to the BIOS;
in a case of remotely logging in to the BIOS, generating an interrupt instruction carrying the second register data; and
sending the interrupt instruction to the BIOS, to cause the BIOS, in response to the interrupt instruction to perform fault information processing on the external device to generate the second log.

12. The method according to claim 11, wherein the remotely logging into the BIOS comprises:
logging in to the BIOS through a Struts, Spring, Hibernate or SpringMVC, Spring, Hibernat (SSH) channel.

13. The method according to claim 1, wherein the determining a running state of the external device according to the first log and standard register data corresponding to the first error information comprises:
extracting the second register data from the first log;
in a case where the second register data is different from the standard register data, determining that the running state of the external device is the fault state; and
in a case where the second register data is the same as the standard register data, determining that the running state of the external device is the normal state.

14. The method according to claim 1, wherein the determining a running state of the BIOS according to the second log and a standard log corresponding to the first register data comprises:
in a case where the second log is different from the standard log, determining that the running state of the BIOS is the fault state; and
in a case where the second log is the same as the standard log, determining that the running state of the BIOS is the normal state.

15. The method according to claim 1, wherein the determining a running state of the BIOS according to the second log and a standard log corresponding to the first register data comprises:
extracting actual location information of the external device where a fault occurs and actual register data corresponding to the external device where the fault occursan from the second log;
extracting standard error location information from the standard log;
in a case where the actual location information is different from the standard error location information, or the actual register data is different from the first register data, determining that the running state of the BIOS is the fault state; and
in a case where the actual location information is the same as the standard error location information, and the actual register data is the same as the first register data, determining that the running state of the BIOS is the normal state.

16. The method according to claim 1, wherein the external device comprises a Peripheral Component Interconnect Express (PCIe) device.

17. An apparatus of detecting a fault for an external device, the external device being in communication connection with a Basic Input Output System (BIOS), wherein the apparatus comprises:
an execution unit, configured to execute a preset operation according to target information, wherein the execution unit is configured to execute the preset operation according to the target information by following steps: in a case where the target information comprises first error information, executing the preset operation of injecting the first error information into the external device, and in a case where the target information comprises first register data, executing the preset operation of sending the first register data to the BIOS, wherein the first register data is register data generated by a register, which simulates the external device, in response to second error information;
a first acquisition unit, configured to acquire a first log, and/or, a second log reported by the BIOS, wherein the first log is a log obtained by the BIOS parsing second register data, the second register data is register data generated by the register in response to the first error information, and the second log is a log obtained by the BIOS parsing the first register data; and
a first determination unit, configured to determine a running state of the external device according to the first log and standard register data corresponding to the first error information, and/or determine a running state of the BIOS according to the second log and a standard log corresponding to the first register data, wherein the running state is a fault state or a normal state.

18. A non-volatile computer readable storage medium, in which a computer program is stored, wherein the computer program is executed by a processor to implement steps of the method according to claim 1 are executed.

19. A processor, configured to run a program, wherein when the program is run, steps of the method according to claim 1 are executed.

20. A system of detecting a fault for a server, comprising:
a Peripheral Component Interconnect Express (PCIe) device;
a Basic Input Output System (BIOS), which is in communication connection with the PCIe device, and is configured to perform fault information processing on the PCIe device to generate a log; and
a test device, comprising a memory, a processor, and a computer program stored in the memory and executable on the processor, wherein the processor implements, when executing the computer program, steps of the method according to claim 1, to detect a running status of the PCIe device, and/or, a running status of the BIOS.
